(19) United States
(12) Patent Application Publication
(10) Pub. No.: US 2017/0132718 A1
(43) Pub. Date: May 11, 2017

(54) METHOD AND SYSTEM FOR CREATING A GRAPHICAL REPRESENTATION OF DATA

(71) Applicant: UanalyzeIT Corporation, Taipei City (TW)

(72) Inventors: Yu-Sheng FAN, Taipei City (TW); Yi-Syuan SHIH, Taipei City (TW); Chung-Ching NI, Taipei City (TW); Yi-Li TU, Taipei City (TW)

(73) Assignee: UanalyzeIT Corporation, Taipei City (TW)

(21) Appl. No.: 15/342,254

(22) Filed: Nov. 3, 2016

(30) Foreign Application Priority Data
Nov. 6, 2015 (TW) 104136697

(51) Int. Cl. G06Q 40/00; G06T 11/20

(52) U.S. Cl. CPC G06Q 40/12; G06T 11/206; G06F 3/04842

(57) ABSTRACT

A method for creating a graphical representation of data includes: obtaining at least one data set of financial data of a company including a first statistic value corresponding to a first time segment of a specific time period, and a second statistic value corresponding to a second time segment of the specific time period different from the first time segment; calculating a comparison value by comparing the first and second statistic values; and generating heat map data used to graphically represent the comparison value in a heat map, the heat map including at least one frame that contains a name associated with the at least one entry of financial data and that is filled by a color based on the comparison value.

### CROSS-REFERENCE TO RELATED APPLICATIONS

This application claims priority of Taiwanese Patent Application No. 104136697, filed on Nov. 6, 2015.

### TECHNICAL FIELD

The disclosure relates to a method and a system for creating a graphical representation of data.

### BACKGROUND

Conventionally, various statistical data may be listed on a statistical statement. For example, a financial statement may include financial data of a company. In some examples, the financial data collected from different time periods may be simultaneously listed on the statistical statement, as illustrated by FIG. 1.

### SUMMARY

One object of the disclosure is to provide a method for creating a graphical representation of data.

According to one embodiment of the disclosure, the method is implemented by an analysis device that includes a processor. The method includes the steps of:

obtaining, by the processor, at least one data set of financial data of a company that is collected within a specific time period, the at least one data set including a first statistic value that corresponds to a first time segment of the specific time period, and a second statistic value that corresponds to a second time segment of the specific time period, the second time segment being different from the first time segment;

calculating, by the processor, a comparison value between the first statistic value and the second statistic value by comparing the first statistic value and the second statistic value; and

generating, by the processor, heat map data based at least in part on the comparison value and a name associated with the at least one data set to graphically represent the comparison value in a heat map, the heat map including at least one frame that contains the name associated with the at least one entry of financial data and that is filled by a color based on the comparison value.

According to another embodiment of the disclosure, the method is implemented by a system that includes an analysis device and a client device communicating with the analysis device. The method includes the steps of:

obtaining, by the analysis device, at least one data set of financial data of a company that is collected within a specific time period, the at least one data set including a first statistic value that corresponds to a first time segment of the specific time period, and a second statistic value that corresponds to a second time segment of the specific time period, the second time segment being different from the first time segment;

calculating, by the analysis device, a comparison value between the first statistic value and the second statistic value by comparing the first statistic value and the second statistic value;

generating, by the analysis device, heat map data based at least in part on the comparison value and a name associated with the at least one data set;

transmitting, by the analysis device, the heat map data to the client device; and

creating, by the client device, a heat map for graphically representing the comparison value according to the heat map data, the heat map including at least one frame that contains the name associated with the at least one data set and that is filled by a color based on the comparison value.

Another object of the disclosure is to provide a system that is capable of performing the above-mentioned method.

The system includes an analysis device including a processor and a data storage device, and a client device communicating with the analysis device. The processor is programmed to perform the steps of:

obtaining at least one data set of financial data of a company from the data storage device, the at least one data set being collected within a specific time period, and including a first statistic value that corresponds to a first time segment of the specific time period, and a second statistic value that corresponds to a second time segment of the specific time period, the second tiem segment being different from the first time segment;

calculating a comparison value between the first statistic value and the second statistic value by comparing the first statistic value and the second statistic value;

generating heat map data based at least in part on the comparison value and a name associated with the at least one data set;

transmitting the heat map data to the client device; and

creating a heat map for graphically representing the comparison value according to the heat map data, the heat map including at least one frame that contains the name associated with the at least one data set and that is filled by a color based on the comparison value.

### BRIEF DESCRIPTION OF THE DRAWINGS

Other features and advantages of the disclosure will become apparent in the following detailed description of the embodiments with reference to the accompanying drawings, of which:

FIG. 1 illustrates a portion of a conventional financial statement;

FIG. 2 is a block diagram illustrating a system for creating a graphical representation of data, according to one embodiment of the disclosure;

FIG. 3 is a flow chart illustrating steps of a method for creating a graphical representation of data, according to one embodiment of the disclosure;

FIG. 4 is a flow chart illustrating steps for determining a saturation value, according to one embodiment of the disclosure;

FIG. 5 illustrates a heat map generated using the method as illustrated in FIG. 3;

FIG. 6 is a flow chart illustrating operations that are available to a user after the graphical representation of data is created, according to one embodiment of the disclosure; and

FIGS. 7 to 11 illustrate the heat map being displayed along with various trend charts, according to one embodiment of the disclosure.

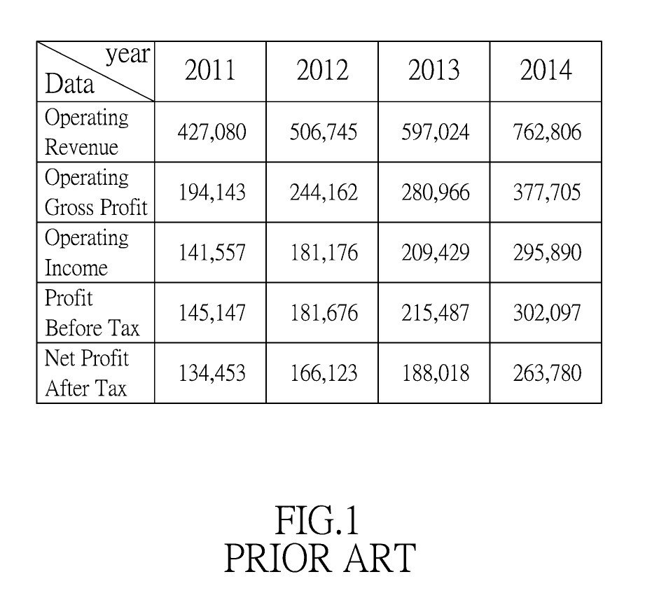

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

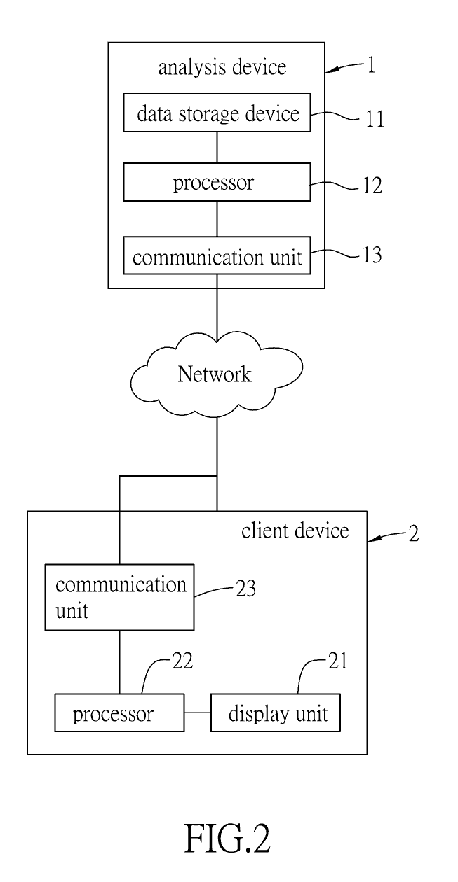

FIG. 2 illustrates a system for creating a graphical representation of data according to one embodiment of the disclosure. In this embodiment, the system includes an analysis device 1 and a client device 2.

The analysis device 1 may be embodied using a computer server, and includes a data storage device 11, a processor 12 and a communication unit 13.

The data storage device 11 may be embodied using a physical storage device such as a hard disk drive (HDD), a solid state drive (SSD), etc. The processor 12 is coupled to the data storage device 11. The communication unit 13 is coupled to the processor 12, and is capable of communicating with the client device 2 over a network (e.g., the Internet).

The client device 2 may be embodied using a personal computer, a laptop, a tablet, a mobile device, etc., and includes a display unit 21, a processor 22 and a communication unit 23. The display unit 21 may be embodied using a display screen. The communication unit 23 is capable of communicating with the analysis device 1 over the network. As such, the analysis device 1 and the client device 2 may form a client-server model where the analysis device 1 acts as a server, and the client device 2 acts as a client.

The data storage device 11 of the analysis device 1 stores financial data of a number of companies therein, and a number of identification codes corresponding to the companies, respectively. In this embodiment, the companies may include ones that are listed in the Taiwan Stock Exchange (TWSE) or the Taipei Exchange (TPEX).

Specifically, the financial data regarding each company may include a plurality of data sets respectively corresponding to different types of data that include, but are not limited to, an operating profit, an operating gross profit, an operating expense, an operating income, an operating cost, a marketing expense, a management expense, a research and development expense, a non-operating profit, a non-operating income, a non-operating expense, a profit before tax, a profit after tax and an earnings per share (EPS) of the company. In other embodiments, the data may further include data constituting one of a balance sheet and a cash flow statement.

The various data sets of the financial data for each company may be collected from the time when the company becomes listed, and the processor 12 is operable to retrieve at least a part of the financial data that is collected within a specific time period (e.g., a calendar month, a quarter of a fiscal year, a fiscal year, a quarter of a calendar year, a calendar year, etc.) for further processing.

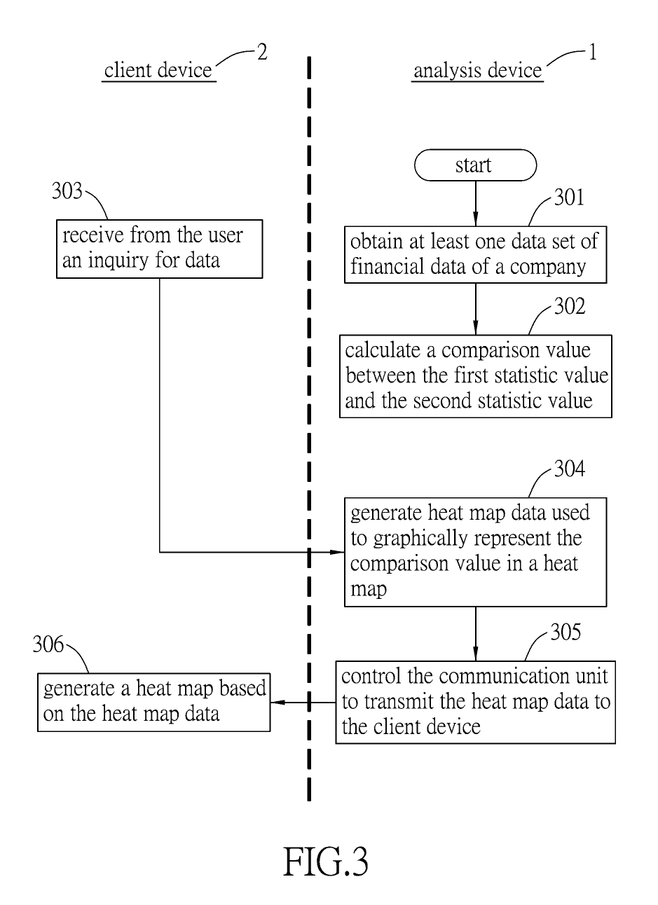

FIG. 3 illustrates steps of a method for creating a graphical representation of data, to be implemented by the system as depicted in FIG. 2.

In this embodiment, a user of the client device 2 may operate the client device 2 using a web browser (e.g., Mozilla Firefox, Google Chrome, etc.) that executes HyperText Markup Language 5 (HTML5) and Java Scripts to communicate with the analysis device 1 for implementing the method. Moreover, the user may be interested in financial data of a particular company whose stock is listed in the TWSE or the TPEX.

In step 301, the processor 12 of the analysis device 1 obtains from the data storage device 11 at least one data set of the financial data of a company that is collected within a specific time period.

For example, the at least one data set of the financial data includes at least a first statistic value that corresponds to a first time segment of the specific time period and that is for instance calculated from data of the corresponding type collected within the first time segment, and a second statistic value that corresponds to a second time segment of the specific time period, and that is for instance calculated from data of the corresponding type collected within the second time segment, where the second time segment is different from the first time segment. It is noted that one or more of the above-mentioned data sets of the financial data may be obtained in step 301, and the operations in step 301 may be executed for each of the companies whose financial data is stored in the data storage device 11.

In step 302, for each data set obtained in step 301, the processor 12 calculates a comparison value between the first statistic value and the second statistic value by comparing the first statistic value and the second statistic value. The comparison value may then be stored in the data storage device 11.

In step 303, the client device 2 receives from the user an inquiry for data. The user may direct the inquiry to one of the companies using a name of the company, or the identification code (e.g., a stock symbol number) corresponding to the company. In this embodiment, the stock symbol number is used as the inquiry. For example, a user input of the stock symbol number “1101” indicates an inquiry to the financial data of the company “Taiwan Cement Corporation”. Then, the client device 2 transmits the inquiry to the analysis device 1.

In step 304, in response to the inquiry, the processor 12 of the analysis device 1 generates heat map data used for graphically representing the comparison value in a heat map 4.

Particularly, the heat map may include at least one frame that contains a name associated with the data set (or type of data) of the financial data and that is filled by a color based on the comparison value.

Afterward, in step 305, the processor 12 controls the communication unit 13 to transmit the heat map data to the client device 2, in order to enable the client device 2 to display the heat map according to the heat map data.

In step 306, the communication unit 23 of the client device 2 receives the heat map data from the analysis device 1, and the processor 22 of the client device 2 is capable of generating a heat map based on the heat map data thus received. Afterward, the client device 2 may be operable to display the heat map.

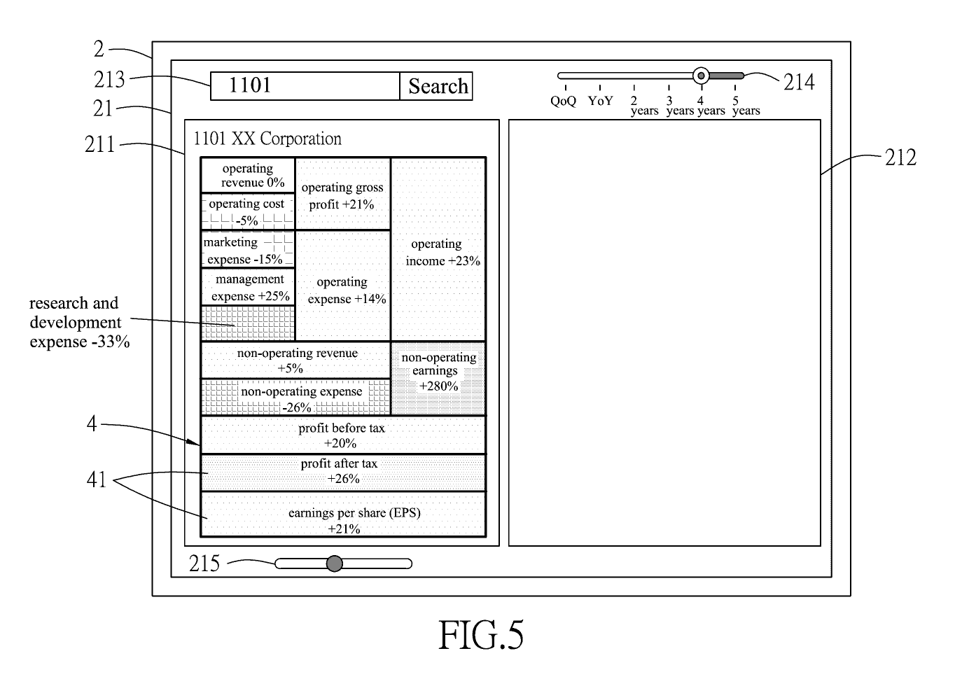

FIG. 5 illustrates an exemplary heat map 4 that is generated and displayed by the client device 2.

After the user has inputted the inquiry in an inquire block 213 (the stock symbol number “1101”) in step 303, the client device 2 communicates with the analysis device 1 to obtain the heat map data associated with Taiwan Cement Corporation in step 305.

In this embodiment, the heat map data includes all data sets of the financial data collected within the specific time period (e.g., the previous four fiscal years 2011 to 2014), the first time segment is the fiscal year 2011, and the second time segment is the fiscal year 2014. In this embodiment, the data set further includes two other static values that correspond to the fiscal years 2012 and 2013, respectively.

The processor 12 is programmed to obtain the comparison value for each data set of the financial data, and the comparison value indicates a growth rate from the first statistic value to the second statistic value. For example, the comparison value for the operating profit of the company is 23%; that is to say, the operating profit of the company in the fiscal year 2014 is 23% more than that in the fiscal year 2011. Similarly, the research and development expense of the company in the fiscal year 2014 is 33% less than that in the fiscal year 2011, and the comparison value for the research and development expense is −33%.

It is noted that the calculation of the comparison value for each data set of the financial data may be done in advance (i.e., before the inquiry from the client device 2), and pre-stored in the data storage device 11 for later use.

After the inquiry, the user is able to select different settings with regard to time (e.g., to alter the specific time period, or to select the first/second time segments) using the selection bar 214 shown in FIG. 5. For example, when the user selects “3 years”, a time period of the previous three fiscal years 2012 to 2014 serves as the specific time period, the fiscal year 2012 serves as the first time segment, and the fiscal year 2014 serves as the second time segment. The same applies to when “2 years”, “4 years” or “5 years” in the selection bar 214 is selected. When the user selects “QoQ” (i.e., quarter-on-quarter), the current quarter of the current calendar or fiscal year serves as the first time segment, and an immediately previous quarter of the same calendar or fiscal year serves as the second time segment. When the user selects “YoY” (i.e., year-on-year), the current calendar or fiscal year serves as the first time segment, and the immediately the same quarter in previous calendar or fiscal year serves as the second time segment. In this embodiment, the first time segment and the second time segment have the same length. Generally speaking, each of the first time segment and the second time segment may be one of a calendar month, a quarter of a calendar year, a calendar year, a quarter of a fiscal year, and a fiscal year.

The comparison values thus acquired for the data sets of the financial data are all incorporated into the heap map data, along with a name for each data set, and transmitted to the client device 2.

The processor 22 of the client device 2 is programmed to then generate the heat map 4 using the heat map data, and display the heat map 4 on a left portion 211 of the display unit 21 using the HTML5 technique. The heat map 4 includes a plurality of the frames, each representing one specific data set of the financial data.

In particular, for each of the frames, a name associated with the data set (or the type of data) of the financial data is displayed, and a color is used to fill the frame. In this embodiment, a red color (represented by dots, for example, in the “operating profit” frame of FIG. 5) is used to indicate a positive comparison value, a green color (represented by the letters “L”, for example, in the “non-operating expenses” frame of FIG. 5) is used to indicate a negative comparison value, and a gray color (for example, in the “operating income” frame of FIG. 5) is used to indicate a comparison value that equals zero. Additionally, the comparison value for each of the data sets of the financial data may be represented in the respective frame of the heat map 4.

The processor 22 of the client device 2 may be further programmed to determine a saturation value of the color for each of the frames (for instance, in FIG. 5, the higher the saturation value of the color “red”, the more dense the “dots” in the frames). Specifically, the saturation value is positively correlated with an absolute value of the comparison value. This is done to further distinguish visually various values of the comparison value.

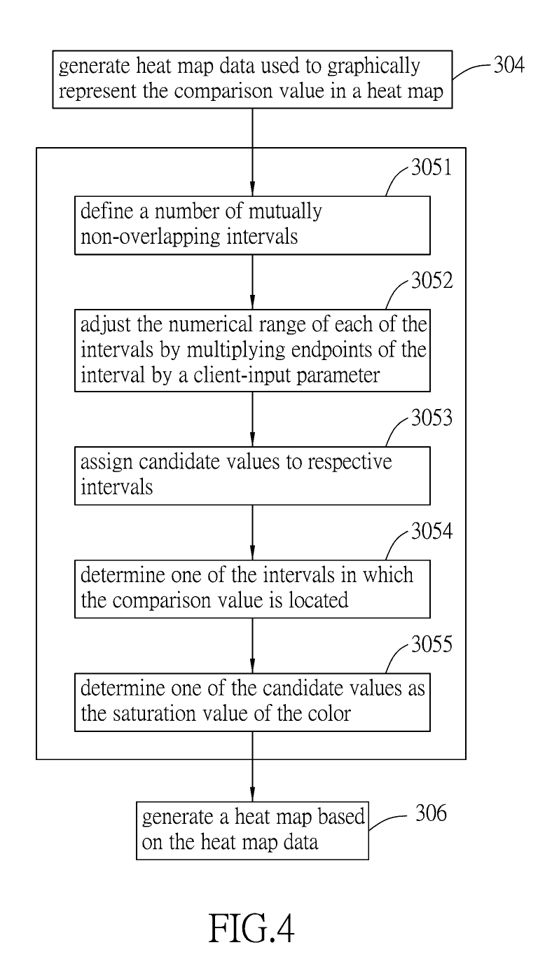

FIG. 4 illustrates sub-steps of step 305, in which the processor 22 determines the saturation value.

In sub-step 3051, the processor 22 defines a number of mutually non-overlapping intervals. For example, four intervals, namely a first interval having a numeral range of (0, 25%], a second interval having a numeral range of (25%, 50%], a third interval having a numeral range of (50%, 75%], and a fourth interval having a numeral range of (75%, ∞] may be defined.

In sub-step 3052, the processor 22 adjusts the numerical range of each of the intervals by multiplying endpoints of the interval by a client-input parameter. The client-input parameter may be adjusted by the user using an adjustment bar 215 (see FIG. 5).

For example, when the client-input parameter is 100, the four intervals are unchanged. When the client-input parameter is 10, the numerical ranges of the first to fourth intervals are changed to (0, 2.5%], (2.5%, 5%], (5%, 7.5%] and (7.5%, ∞], respectively.

In sub-step 3053, the processor 22 assigns first to fourth candidate values to the first to fourth intervals, respectively. Specifically, one of the intervals having endpoints with higher absolute values is assigned with a higher candidate value. For example, the first candidate value assigned to the first interval having end points of 0 and 25% indicates a lowest saturation, and the fourth candidate value assigned to the fourth interval having end points of 75% and ∞ indicates a greatest saturation.

In sub-step 3054, for each data set of the financial data, the processor 22 determines one of the intervals in which the comparison value is located.

In sub-step 3055, for each data set of the financial data, the processor 22 determines one of the candidate values that is assigned to the one of the intervals, within the numerical range of which the comparison value of the data set falls, as the saturation value of the color.

For example, the frame “non-operating profit”, which has a comparison value of 280%, is filled by the red color with the greatest saturation indicated by the fourth candidate value. The frame “profit after tax” having a comparison value of 26% is filled by the red color with a second lowest saturation indicated by the second candidate value. The frame “profit before tax” having a comparison value of 20% is filled by the red color with the lowest saturation indicated by the first candidate value. The frame “research and development expense” having a comparison value of −33% is filled by the green color with the second lowest saturation indicated by the second candidate value. The frame “marketing expense” having a comparison value of −15% is filled by the green color with the lowest saturation indicated by the first candidate value.

It is noted that in FIG. 5, densities of the dots (associated with the red color) and the “L's” (associated with the green color) are used to indicate the saturation. For example, the frame “non-operating profit” is filled more densely with the dots than the frame “profit before tax”.

In the case that the client-input parameter is 10, and the numerical ranges of the four intervals become (0, 2.5%], (2.5%, 5.0%], (5.0%, 7.5%], and (7.5%, ∞], respectively, most of the frames in the heat map (other than the frames “non-operating profit”, “operating costs”, and “operating profit”) will be assigned with the fourth interval and thus the fourth candidate value. Namely, the client-input parameter affects sensibility of the saturation of the color with regard to changes in the comparison value indicated in each frame of the heat map 4. The lower the client-input parameter, the greater the sensibility of the saturation of the color to changes in the comparison value. Each time the client-input parameter is adjusted, the saturation of the color for filling each of the frames may be adjusted accordingly.

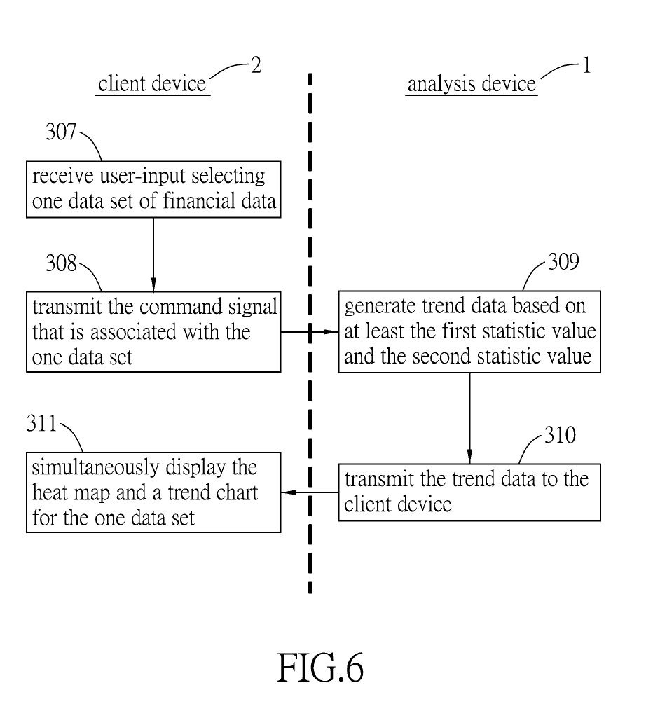

FIG. 6 illustrates steps of additional operations that can be performed based on the financial data.

Specifically, in step 307, when the user is interested in one data set of the financial data in more details, he/she may click on the corresponding one of the frames displayed in the heat map 4, so as to enable the client device 2 to generate a command signal. Alternatively, the user may drag the one of the frames to a right portion 212 of the display unit 21. That is to say, the command signal is generated by the client device 2 in response to one of a click operation and a drag operation that is associated with the at least one data set and that is performed on the client device 2.

In response to the above user-input, in step 308, the client device 2 transmits the command signal that is associated with one data set of the financial data to the analysis device 1.

In response to the command signal, in step 309, the processor 12 generates trend data based on at least the first statistic value and the second statistic value of the data set. In this embodiment, the processor 12 generates the trend data that includes the four statistic values corresponding to the fiscal years 2011-2014.

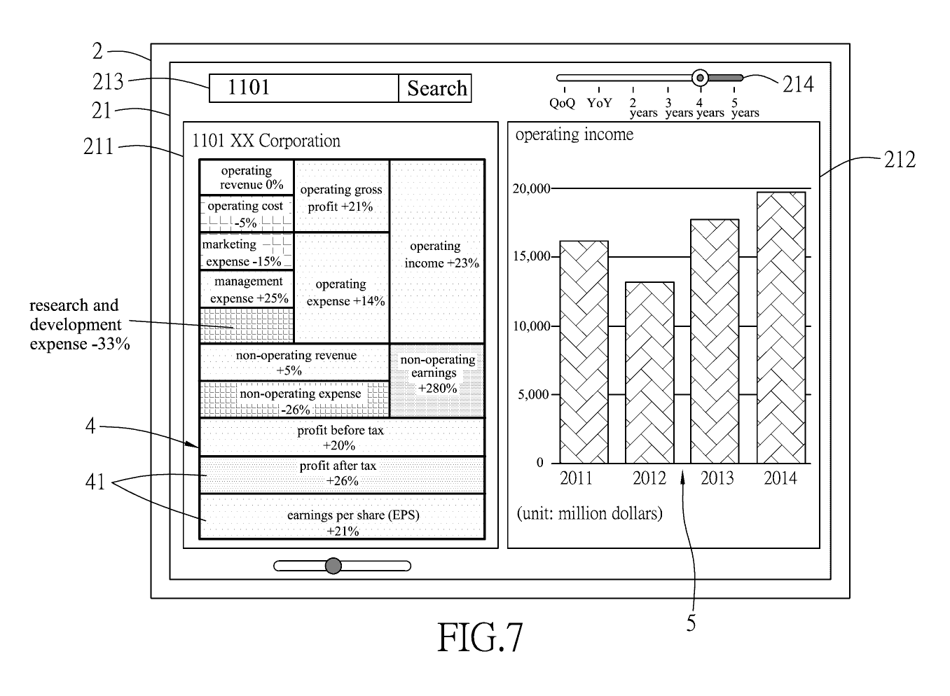

Then, in step 310, the processor 12 transmits the trend data to the client device 2. In response, in step 311, the client device 2 simultaneously displays the heat map 4 and a trend chart 5 for the data set of interest (see FIG. 7).

It is noted that, in this embodiment, the trend chart 5 is generated by the client device 2 based on the trend data. Specifically, the generation of the trend chart 5 may be done using the HTML5 technique.

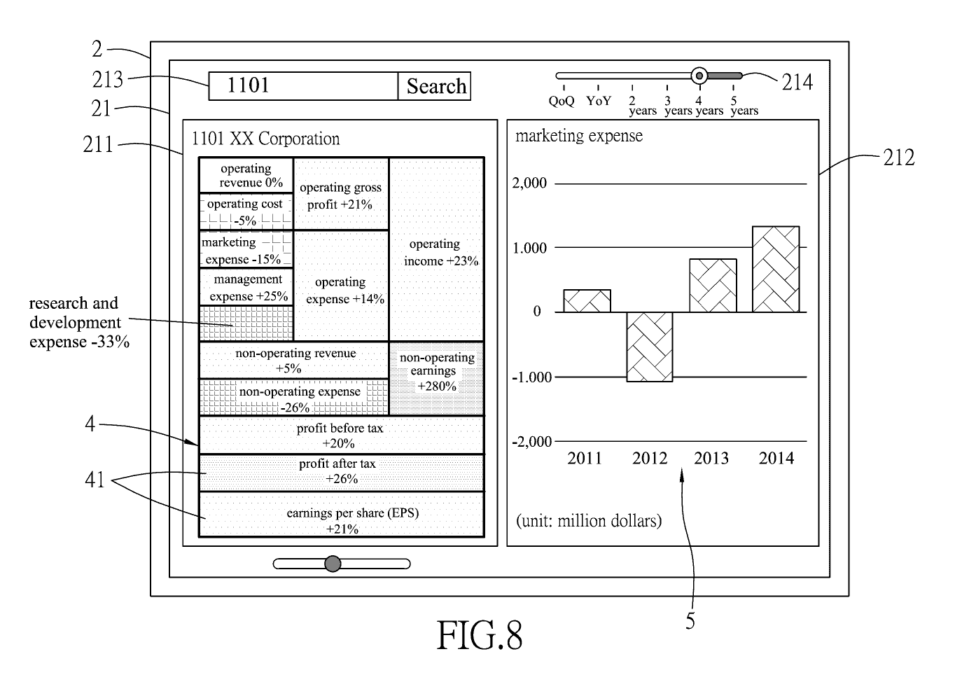

In use, when the user selects, for example, the frame “non-operating profit” in the heat map 4, the client device 2 in turn transmits the command signal to request the trend data associated with the data set of the non-operating profit of the company. After receiving the trend data from the analysis device 1, the client device 2 displays the heat map 4 and the trend chart 5 on the display unit 21 simultaneously. In this example, the trend chart 5 includes a bar chart illustrating the non-operating profit of the company collected within each of the fiscal years 2011 to 2014 (see FIG. 8).

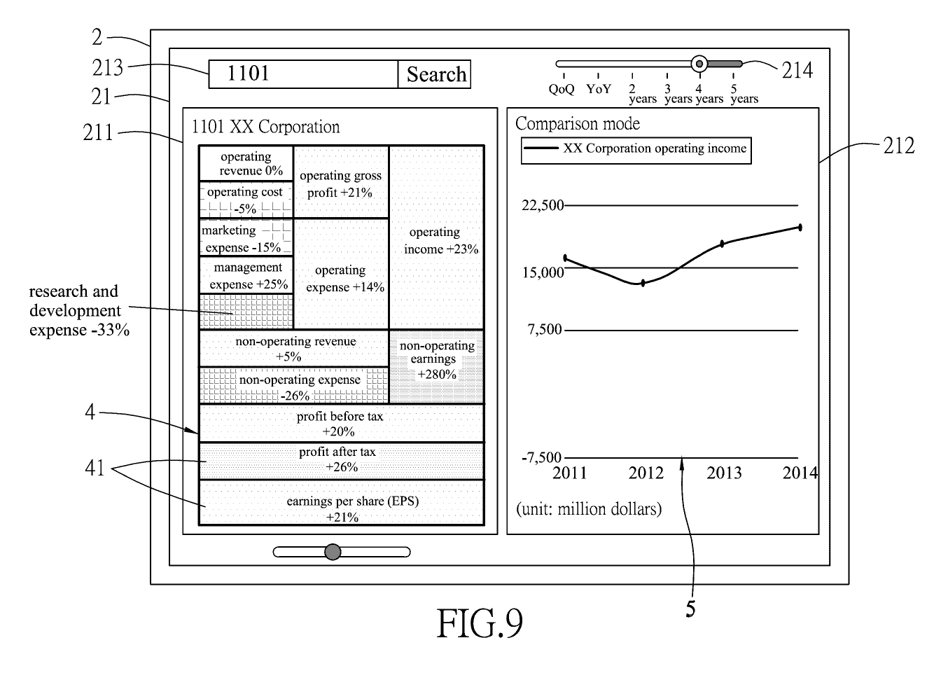

Alternatively, the trend chart 5 may be in other forms. For example, as illustrated in FIG. 9, when the user drags the frame “operating profit” in the heat map 4 to the right portion 212, the operating profit is displayed in a run chart.

In one embodiment of the disclosure, the processor 22 may operate in a comparison mode. That is to say, the user may be able to select more than one frame to enable the corresponding data to be displayed on the same trend chart 5.

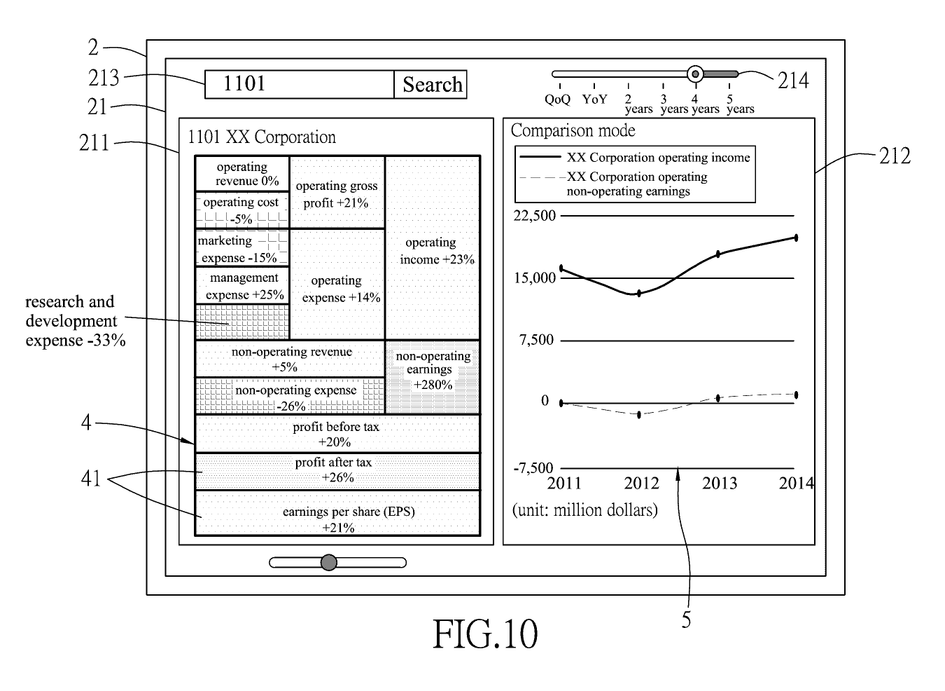

As illustrated in FIG. 10, after the frame “operating profit” is selected and the run chart is displayed, the user may further select another frame (e.g., the non-operating profit). In response, a run chart of the non-operating profit is displayed in the same trend chart 5 as the run chart of the operating profit.

In one embodiment of the disclosure, the comparison mode may allow financial data of another company to be displayed simultaneously on the trend chart 5.

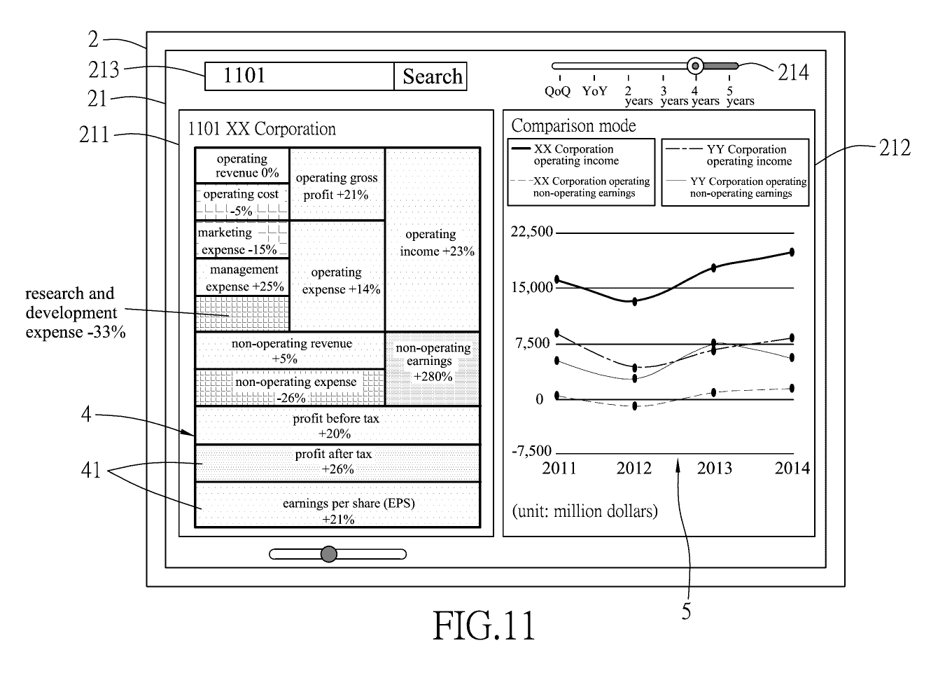

As illustrated in FIG. 11 (which is a continuation of FIG. 10), the user may input another symbol number (e.g., 1102 indicating Asia Cement Corporation) into the inquire block 213. In response, the heat map 4 associated with the Asia Cement Corporation is generated and displayed in the left portion 211.

Afterward, the user may drag the frames “operating profit” and “non-operating profit” into the right portion 212, and as a result, the run charts of the operating profit and the non-operating profit for both the Taiwan Cement Corporation and the Asia Cement Corporation are displayed on the trend chart 5.

In one embodiment of the disclosure, the analysis device 1 is embodied using a computer host, and the client device 2 is embodied using a display device that is physically connected to the analysis device 1 via an interface (e.g., a video graphics array (VGA) connector or a high definition multimedia interface (HDMI)).

In this embodiment, the client device 2 may be without a processor, and the processor 12 of the analysis device 1 is programmed to perform all operations other than the displaying of data.

To sum up, the method and system as described in the disclosure provide a way to graphically represent the financial data in a heat map, in order to allow the user to easily identify the comparison value of each data set by simply looking at the color of the corresponding frame included in the heat map 4. Moreover, the system may operate in the comparison mode to allow multiple types of the data, from one or more companies, to be compared in the same trend chart 5.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding various inventive aspects.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A method for creating a graphical representation of data, the method being implemented by an analysis device that includes a processor, the method comprising the steps of:
obtaining, by the processor, at least one data set of financial data of a company that is collected within a specific time period, the at least one data set including a first statistic value that corresponds to a first time segment of the specific time period, and a second statistic value that corresponds to a second time segment of the specific time period, the second time segment being different from the first time segment;
calculating, by the processor, a comparison value between the first statistic value and the second statistic value by comparing the first statistic value and the second statistic value; and
generating, by the processor, heat map data based at least in part on the comparison value and a name associated with the at least one data set to graphically represent the comparison value in a heat map, the heat map including at least one frame that contains the name associated with the at least one data set and that is filled by a color based on the comparison value.

2. The method of claim 1, wherein the comparison value is represented in the frame of the heat map.

3. The method of claim 1, the system further including a communication unit coupled to the processor and capable of communicating with a client device, the method further comprising the step of controlling, by the processor, the communication unit to transmit the heat map data to the client device to enable the client device to display the heat map according to the heat map data.

4. The method of claim 1, the system further including a communication unit coupled to the processor and capable of communicating with a client device, the method further comprising the steps of:
receiving, by the processor through the communication unit, a command signal that is associated with the at least one data set from the client device;
generating, by the processor, trend data based on at least the first statistic value and the second statistic value; and
controlling, by the processor, the communication unit to transmit the trend data to the client device to enable the client device to display the heat map and a chart for illustrating a trend of the at least one data set simultaneously with the heat map.

5. The method of claim 1, wherein the command signal is generated by the client device in response to one of a click operation and a drag operation that is associated with the at least one data set and that is performed on the client device.

6. The method of claim 1, wherein the at least one data set indicates one of an operating income, an operating gross profit, an operating expense, an operating revenue, an operating cost, a marketing expense, a management expense, a research and development expense, non-operating earnings, a non-operating revenue, a non-operating expense, a profit before tax, a profit after tax, and an earnings per share (EPS) of the company.

7. The method of claim 1, wherein the at least one data set indicates data constituting one of a balance sheet and a cash flow statement.

8. The method of claim 1, wherein:
the first time segment and the second time segment have the same length, and each of the first time segment and the second time segment is one of a calendar month, a quarter of a fiscal year, a fiscal year, a quarter of a calendar year, and a calendar year; and
the comparison value indicates a growth rate from the first statistic value to the second statistic value.

9. A method for creating a graphical representation of data, the method being implemented by a system that includes an analysis device and a client device communicating with the analysis device, the method comprising the steps of:
obtaining, by the analysis device, at least one data set of financial data of a company that is collected within a specific time period, the at least one data set including a first statistic value that corresponds to a first time segment of the specific time period, and a second statistic value that corresponds to a second time segment of the specific time period, the second time segment being different from the first time segment;
calculating, by the analysis device, a comparison value between the first statistic value and the second statistic value by comparing the first statistic value and the second statistic value;
generating, by the analysis device, heat map data based at least in part on the comparison value and a name associated with the at least one data set;
transmitting, by the analysis device, the heat map data to the client device; and
creating, by the client device, a heat map for graphically representing the comparison value according to the heat map data, the heat map including at least one frame that contains the name associated with the at least one data set and that is filled by a color based on the comparison value.

10. The method of claim 9, wherein the comparison value is represented in the frame of the heat map.

11. The method of claim 9, wherein the comparison value is a growth rate from the first statistic value to the second statistic value, and the method further comprises the step of determining, by the client device, a saturation value of the color positively correlating with an absolute value of the comparison value.

12. The method of claim 11, wherein the step of determining the saturation value includes the sub-steps of:
defining a number of mutually non-overlapping intervals;
assigning candidate values to the intervals, respectively, where one of the intervals having endpoints with higher absolute values is assigned with a higher candidate value;
determining one of the intervals in which the comparison value is located; and
determining one of the candidate values that is assigned to the one of the intervals as the saturation value of the color.

13. The method of claim 12, wherein the step of determining the saturation value further includes the sub-step of adjusting a numerical range of each of the intervals by multiplying the endpoints of each of the intervals by a predetermined parameter.

14. The method of claim 9, further comprising the steps of:
receiving, by the analysis device, a command signal that is associated with the at least one data set from the client device;
generating, by the analysis device, trend data based on the first statistic value and the second statistic value;
transmitting, by the analysis device, the trend data to the client device; and
simultaneously displaying, by the client device, the heat map and a trend chart for the at least one data set, the trend chart being generated based on the trend data.

15. A system for creating a graphical representation of data, said system comprising an analysis device including a processor and a data storage device, and a client device communicating with said analysis device,
wherein said processor is programmed to perform the steps of:
obtaining at least one data set of financial data of a company from said data storage device, the at least one data set being collected within a specific time period, and including a first statistic value that corresponds to a first time segment of the specific time period, and a second statistic value that corresponds to a second time segment of the specific time period, is the second time segment being different from the first time segment;
calculating a comparison value between the first statistic value and the second statistic value by comparing the first statistic value and the second statistic value;
generating heat map data based at least in part on the comparison value and a name associated with the at least one data set; and
transmitting the heat map data to said client device;
wherein said client device is programmed to create a heat map for graphically representing the comparison value according to the heat map data, the heat map including at least one frame that contains the name associated with the at least one data set and that is filled by a color based on the comparison value.
